(19) United States
(12) Patent Application Publication
(10) Pub. No.: US 2015/0006155 A1
(43) Pub. Date: Jan. 1, 2015

(54) DEVICE, METHOD, AND PROGRAM FOR WORD SENSE ESTIMATION

(71) Applicants: Koichi Tanigaki, Tokyo (JP); Mitsuteru Shiba, Tokyo (JP); Shigenobu Takayama, Tokyo (JP)

(72) Inventors: Koichi Tanigaki, Tokyo (JP); Mitsuteru Shiba, Tokyo (JP); Shigenobu Takayama, Tokyo (JP)

(73) Assignee: Mitsubishi Electric Corporation, Chiyoda-ku, Tokyo (JP)

(21) Appl. No.: 14/366,066

(22) PCT Filed: Mar. 7, 2012
(86) PCT No.: PCT/JP2012/055818

§ 371 Date: Jun. 17, 2014

(51) Int. Cl. G06F 17/28; G06F 17/27

(52) U.S. Cl. CPC G06F 17/28; G06F 17/27
USPC 704/9

(57) ABSTRACT

A device and method to estimate a word sense with high accuracy by unsupervised learning. A word sense estimation device executes a plurality of number of times a probability calculation of calculating an evaluation value for each word of a case where each concept extracted as a word sense candidate is determined as a word sense, based on a proximity between a context feature of a selected word and a context feature of another word, a proximity between a selected concept and a word sense of this another word, and a probability that the selected word takes a selected word sense, and of re-calculating the probability based on the evaluation value calculated, and estimates a concept with a higher probability calculated of said each word, to be a word sense of the word.

### TECHNICAL FIELD

The present invention relates to a word sense estimation technique (word sense disambiguation technique) which estimates, for a word included in a document, in what word sense registered in a dictionary the word is used.

### BACKGROUND ART

Many studies have been made in word sense estimation as the basic technique for various types of natural language processing systems represented by machine translation and information retrieval, and these studies are roughly classified into two approaches.

One approach provides a scheme to which supervised learning (or semi-supervised learning) is applied. The other approach provides a scheme to which unsupervised learning is applied.

In the scheme to which supervised learning is applied, labeled learning data to which a correct word sense is imparted (usually manually) is generated in advance for an object task or document data analogous to it. A rule which discriminates, by a certain criterion (likelihood maximization, margin maximization, or the like), a word sense from an appearing context of a word is learned by a model.

As examples of the scheme to which supervised learning is applied, Non-Patent Literature 1 describes a scheme that employs a support vector machine, and Non-Patent Literature 2 describes a scheme to which Naive Bayes method is applied. Non-Patent Literature 3 describes a semi-supervised learning technique which also employs non-labeled learning data not imparted with a correct word sense, thereby reducing the necessary amount of labeled learning data.

In the scheme to which unsupervised learning is applied, labeled learning data to which a correct answer is imparted manually is not used. A word sense is discriminated only from unlabeled learning data.

As an example of the scheme to which unsupervised learning is applied, according to the scheme described in Patent Literature 1, the word senses of co-occurrence words appearing in the neighbor of a word included in a document are checked on a concept hierarchy, to find a word sense candidate defined by a larger number of co-occurrence words using nearby hierarchies and nearby word sense definition sentences. The found word sense candidate is adopted as the word sense of the word. Namely, among the word sense candidates of the word in question, a candidate with a larger number of nearby word sense candidates for the co-occurrence word is determined to be more plausible, thereby estimating the word sense of the word.

### CITATION LIST

### Patent Literature

Patent Literature 1: JP 2010-225135

### Non-Patent Literature

Non-Patent Literature 1: Leacock, C., Miller, G. A. and Chodorow, M.: Using corpus statistics and wordnet relations for sense identification, Computational Linguistics, Vol. 24, No. 1, pp. 147-165 (1998)
Non-Patent Literature 2: KUROHASHI, Sadao and SHIRAI, Kiyoaki “SENSEVAL-2 Nihon-go task”, Technical Committee on Natural Language Understanding and Models of Communication (NCL), Institute of Electronics, Information and Communication Engineerings, 2001
Non-Patent Literature 3: Yarowsky, D.: Unsupervised word sense discrimination, Computational Linguistics, Vol. 24, No. 1, pp. 97-123 (1998)
Non-Patent Literature 4: KURIBAYASH, Takayuki, Bond, F., KURODA, Kou, UCHIMOTO, Kiyotaka, ISAHARA, Hitoshi, KANZAKI, Kyoko, and TORISAWA, Kentaro: Nihon-go wordnet 1.0, Proceedings of 16th Annual Meeting of the Association for Natural Language Processing (2010)

### SUMMARY OF INVENTION

### Technical Problem

To employ the supervised-learning-applied schemes described in Non-Patent Literatures 1 and 2 and the semi-supervised-learning-applied scheme described in Non-Patent Literature 3, labeled learning data imparted with the correct word sense need be generated for the document data. Accordingly, this scheme has a problem in that generation of the learning data is costly and the scheme cannot be employed in a situation where learning data cannot be obtained in advance.

The unsupervised-learning-applied scheme described in Patent Literature 1 attempts to disambiguate only a word in question. More specifically, the word sense candidates of the co-occurrence words are utilized as the support for the word in question without disambiguating the word senses of co-occurrence words, by treating equally significantly even a word sense candidate that is actually false. Accordingly, this scheme has a problem in that its word sense estimation has poor accuracy.

It is an object of the present invention to estimate a word sense highly accurately by unsupervised learning.

### Solution to Problem

A word sense estimation device according to the present invention includes:

a word extraction part which extracts a plurality of words included in input data;

a context analysis part which extracts, for each word extracted by the word extraction part, a context feature of a context in which the word appears in the input data;

a word sense candidate extraction part which extracts each concept stored as a word sense of said each word, as a word sense candidate of said each word, from a concept dictionary storing at least one concept as a word sense of a word; and

a word sense estimation part which executes a plurality of number of times a probability calculation of calculating an evaluation value for said each word of a case where said each concept extracted as the word sense candidate by the word sense candidate extraction part is determined as a word sense, based on a proximity between the context feature of a selected word and the context feature of another word, a proximity between a selected concept and a concept of a word sense candidate of said another word, and a probability that the selected word takes a selected word sense, and of re-calculating the probability based on the evaluation value calculated, and which estimates a concept with a higher probability calculated of said each word, to be a word sense of the word.

### Advantageous Effects of Invention

The word sense estimation device according to the present invention estimates the word senses of a plurality of words simultaneously, so that even in a case where correct word senses are not given or the correct word senses are given only in a small amount, a high word sense estimation accuracy can be realized.

### BRIEF DESCRIPTION OF DRAWINGS

FIG. 1 is a configuration diagram of a word sense estimation device 100 according to Embodiment 1.

FIG. 2 shows the outline of a word sense estimation scheme according to Embodiment 1.

FIG. 3 shows examples of feature vectors of an appearing context generated by a context analysis part 30.

FIG. 4 shows the relationship between concepts and words.

FIG. 5 is an example of a concept relation definition to show the superior (abstract)-inferior (concrete) relation of a concept.

FIG. 6 shows examples of concepts represented by vectors according to the hierarchy definition shown in FIG. 5.

FIG. 7 is a flowchart showing the flow of a process of estimating a word sense assignment probability π^{wi}ⱼ.

FIG. 8 shows update of a word sense assignment probability π^{w}ⱼ by adopting EM algorithm and how word sense disambiguation takes place accordingly.

FIG. 9 shows an example of the hardware configuration of the word sense estimation device 100.

### DESCRIPTION OF EMBODIMENTS

Preferred embodiments of the present invention will be described with reference to the accompanying drawings.

Note that in the following description, a processing device is a CPU 911 or the like to be described later. A storage device is a ROM 913, a RAM 914, a magnetic disk device 920, or the like (each will be described later). Namely, the processing device and the storage device are hardware.

In the following description, when wi is expressed as a superscript or subscript, wi represents wᵢ.

### Embodiment 1

In Embodiment 1, a word sense estimation scheme will be described through an example where the table schemas of a plurality of databases are treated as an input text data 10 and the word sense of a word constituting the table schemas is to be estimated.

Practical applications of estimating a word sense for a table schema include, for example, corporate data integration. Companies are in need of integrating the data of databases among a plurality of business applications in operation that are constructed separately in the past. To implement data integration, it is necessary to identify which item corresponds to which item among the plurality of databases. Conventionally, this item correspondence identification has been done manually. Employment of a word sense estimation scheme will assist the task of checking whether or not a correspondence is present between items having different names, thus leading to labor reduction.

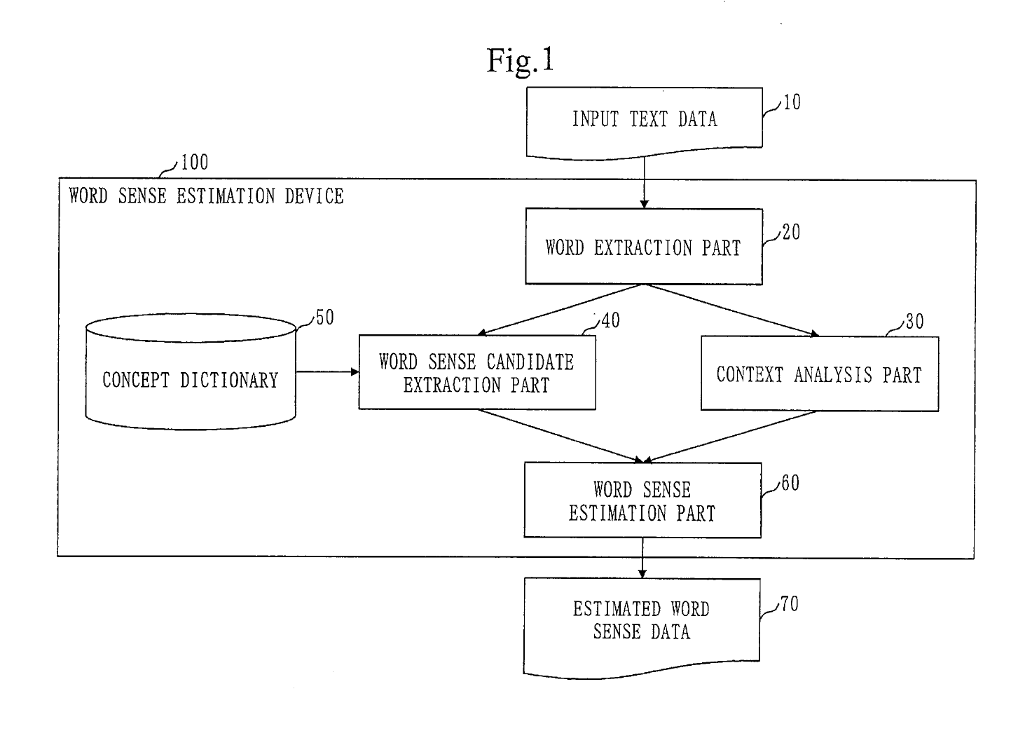

FIG. 1 is a configuration diagram of a word sense estimation device 100 according to Embodiment 1.

The input text data 10 is constituted by a plurality of table schemas of a plurality of databases.

With a processing device, a word extraction part 20 splits a table name and a column name defined by the table schemas into words, and extracts the split words as word sense estimation objects.

With the processing device, a context analysis part 30 extracts from the table schemas the features of contexts in which the respective words extracted by the word extraction part 20 appear.

With the processing device, a word sense candidate extraction part 40 looks up a concept dictionary 50, and extracts a word sense candidate for each word extracted by the word extraction part 20.

The concept dictionary 50 stores, in a storage device, one or more concepts as the word sense of the word as well as the hierarchical relation among the concepts.

A word sense estimation part 60 estimates, for each word extracted by the word extraction part 20, what word sense extracted by the word sense candidate extraction part 40 is most plausible. In this operation, the word sense estimation part 60 estimates the word sense of each word based on a proximity in feature between contexts extracted by the context analysis part 30 for that word and for another word as well as a proximity in concept between the word sense candidate of that word and the word sense candidates of that another word. Then, the word sense estimation part 60 outputs the word sense estimated for each word, as estimated word sense data 70.

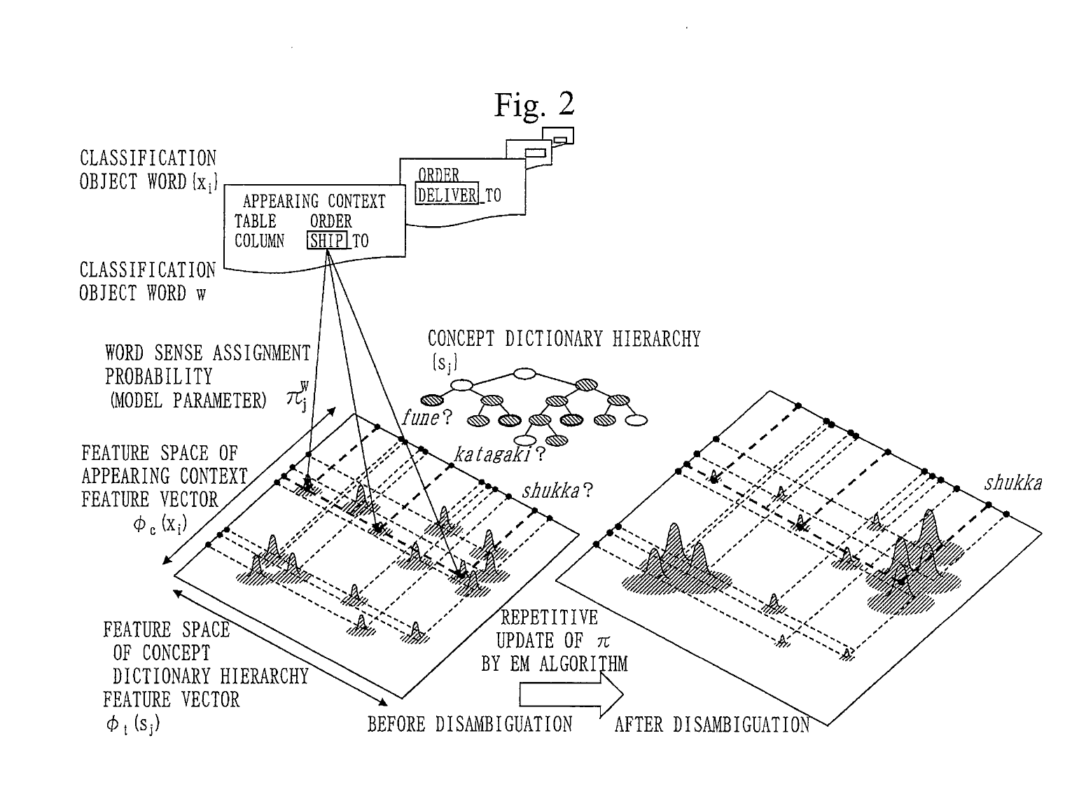

FIG. 2 shows the outline of the word sense estimation scheme according to Embodiment 1.

In FIG. 2, the input text data 10 is constituted by schemas which define the table structure of the database. FIG. 2 shows an example in which the schema of a table “ORDER” including columns “SHIP_TO” and “DELIVER_TO” is inputted. In practice, a plurality of table schemas of this type are inputted.

The word extraction part 20 extracts words from the inputted table schema. In this example, words are split in the simplest manner using an underscore “_” as a delimiter. As a result, in FIG. 2, four types of words: “ORDER”, “SHIP”, “TO”, and “DELIVER” are extracted. The extracted words are all treated as the word sense estimation objects (classification object words).

Based on the result of word splitting done by the word extraction part 20, the context analysis part 30 extracts the features of an appearing context of each classification object word, and generates a feature vector.

The features of a word appearing context express how the word is used in the table schema. Note that as the features of the word appearing context, 5 features will be employed: (1) the type of the appearing portion as to whether the word appears in a table name or a column name; (2) a word appearing immediately before a classification object word; (3) a word appearing immediately after a classification object word; (4) a word appearing in a parent table name (only when the classification object word appears in a column name); and (5) a word appearing in a child column name (only when the classification object word appears in a table name).

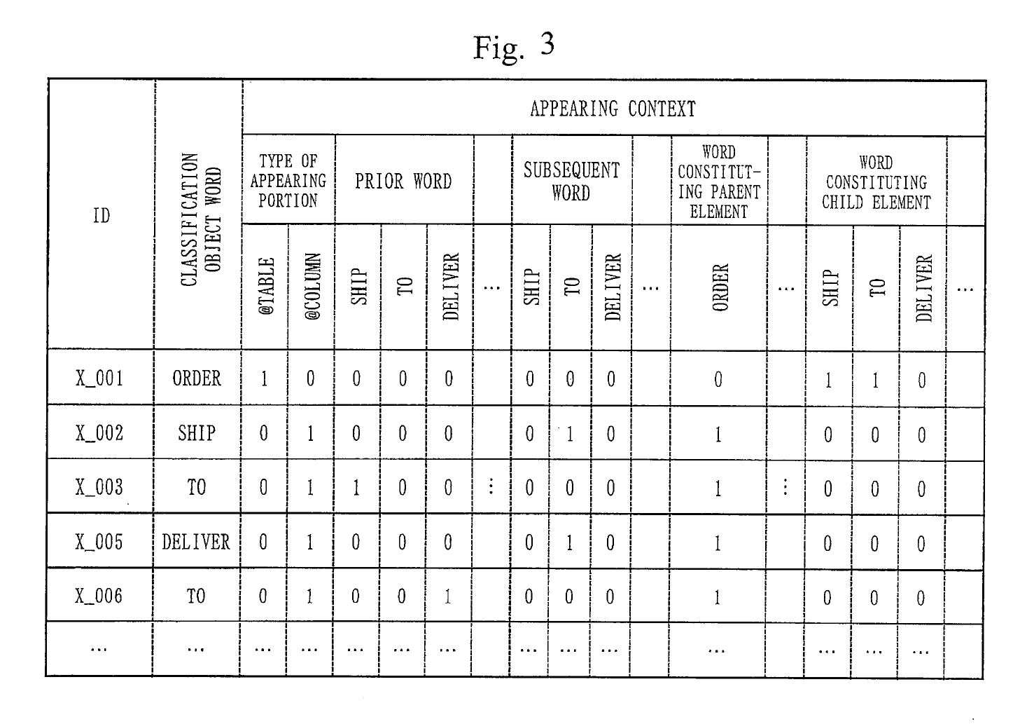

FIG. 3 shows examples of feature vectors of an appearing context generated by the context analysis part 30.

In FIG. 3, each row expresses a classification object word, and each column expresses properties constituting a feature. In FIG. 3, when value 1 is given as a property, the corresponding feature is present, and when value 0 is given as a property, the corresponding feature is absent. It is known from FIG. 3 that a context vector in which a classification object word “SHIP” appears and a context vector in which a classification object word “DELIVER” appears coincide with each other and that the two classification object words are used in similar manners.

The word sense candidate extraction part 40 looks up the concept dictionary 50, and extracts for each classification object word every concept that serves as a word sense candidate.

As the concept dictionary 50, for example, WordNet is employed. In WordNet, a concept called synset is treated as one unit, and a word corresponding to this concept, the superior (abstract)-inferior (concrete) relation between concepts, and the like are defined. The details of WordNet are described in, for example, Non-Patent Literature 4.

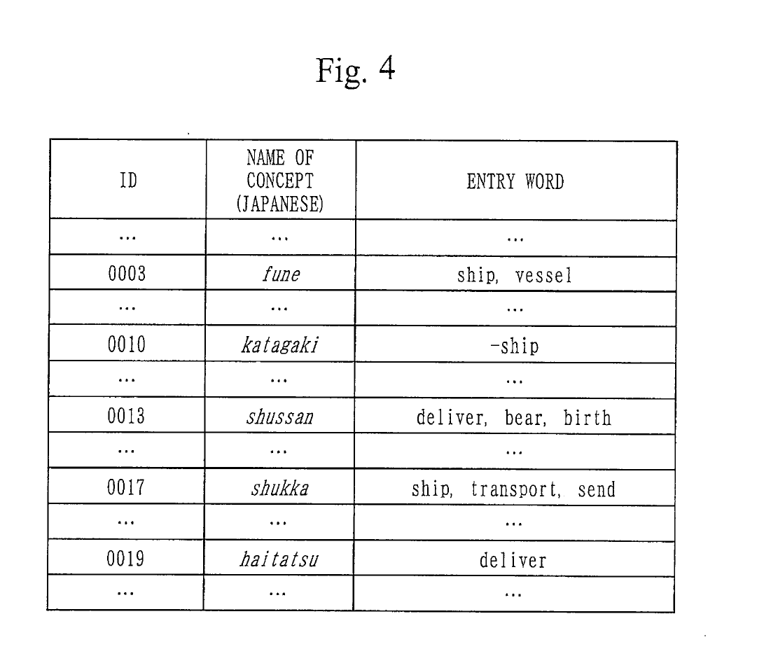

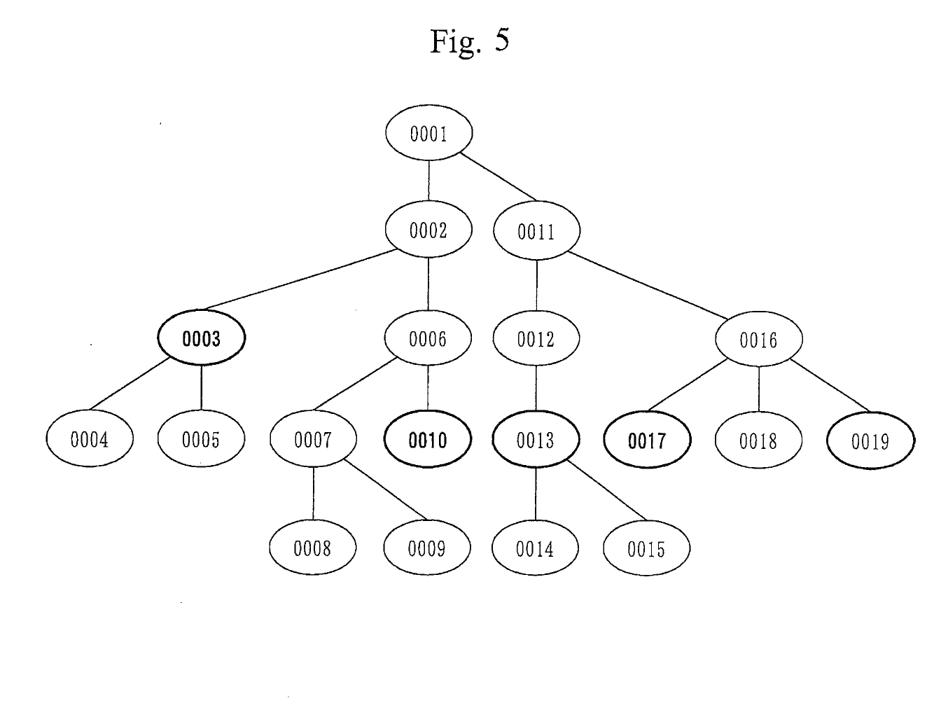

FIGS. 4 and 5 show examples of the concept dictionary 50.

FIG. 4 shows the relationship between concepts and words. That is, FIG. 4 is a table showing word sense definition examples.

For instance, concept ID0003 is defined as being a concept with a name fune in Japanese and corresponding to words such as “ship” and “vessel”. Inversely, when seen from the word “ship”, 3 concepts: ID0003 fune, 0010 katagaki, and 0017 shukka are registered as its word senses. This is ambiguous. Likewise, 2 concepts: ID0013 shussan and 0019 haitatsu are registered as the word senses of a word “deliver”. This is ambiguous. Hence, in what word sense the word “ship” or “deliver” is used must be discriminated from the context.

FIG. 5 is an example of a concept relation definition to show the superior (abstract)-inferior (concrete) relation of a concept.

Concepts that are at close distance along the hierarchical relation have senses similar to each other than concepts that are at far distance. For example, in FIG. 5, the concept shipping of ID0017 is defined as being in a hierarchy of a sister relation with the concept haitatsu of ID0019 and thus having a more similar sense than the concept shussan of another ID0013.

The word sense candidate extraction part 40 extracts the concept registered in the concept dictionary as the word sense of the word and converts the extracted concept into the feature vector of the word sense. Conversion into the feature vector allows treating the proximity of concepts by vector calculation as with the proximity of appearing contexts.

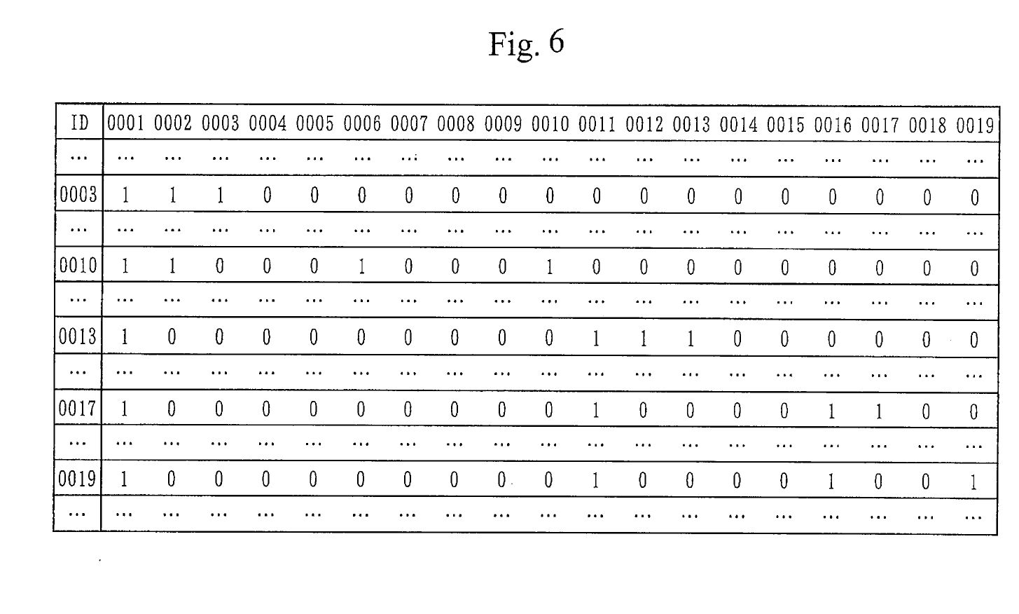

FIG. 6 shows examples of concepts expressed by vectors according to the hierarchy definition shown in FIG. 5.

In FIG. 6, each row expresses the vector of concept ID indicated at the left end. Each component of the vector is a concept that constitutes a concept hierarchy. If the component corresponds to that concept or a concept superior to it, 1 is given to the component; if not, 0 is given to the component. For example, since the concept of ID0017 has ID0001, ID0011, and ID0016 as superior concepts, 1 is given to a total of 4 components, i.e., ID0017 itself and those 3 concepts.

It is seen from FIG. 6 that concepts ID0017 shukka and ID0019 haitatsu are expressed as similar vectors, when compared to other concepts.

The word sense estimation part 60 estimates the word sense of the classification object word based on a feature vector φₖ described above of the appearing context and a feature vector φₜ described above of the word sense.

FIG. 2 shows a feature space constituted by the two vectors described above, as a two-dimensional plane schematically. When a classification object word x is mapped onto this plane, the coordinate of the feature vector φ_{c}(x) of the appearing context of the classification object word x is determined uniquely. As the word sense of the classification object word x is ambiguous, however, the coordinate of the feature vector φₜ(x) of the word sense of the classification object word x appears as hypotheses probabilistically positioned at a plurality of locations. In FIG. 2, the hypotheses mapped on the plane are expressed as black points. For example, classification object word “SHIP” in FIG. 2 has ambiguity on the feature vector φₜ side of the word sense, and its hypotheses are placed at 3 points.

In order to disambiguate the word sense of each word by unsupervised learning, the following two suppositions will be introduced.

<Supposition 1> One lemma is used for the same word sense irrespective of in what context it appears.
<Supposition 2> A word sense closer to the word sense of a word appearing in a closer context is more plausible.

Supposition 1 supposes that when treating the schema of a limited task domain, word ambiguity does not occur, and a consistent word sense can be assigned to the word.

Supposition 2 expects that the supposed consistency in Supposition 1 which is closed for each word will hold with gradual continuity even in a case where the object scope is extended to cover a group of words appearing in similar contexts.

Based on the two suppositions described above, a joint probability p(x, s) of a word sense hypothesis (x, s) of assigning a word sense s to the classification object word x is obtained by Formula 11.

$$p ( x , s ) ≡ \frac{1}{Z} {\sum }_{i = 1}^{N} {\sum }_{j : {s}_{j} ∈ {S}_{{w}_{i}}} {π}_{j}^{{w}_{i}} exp ( - \frac{{‖ {φ}_{c} ( x ) - {φ}_{c} ( {x}_{i} ) ‖}^{2}}{{σ}_{c}^{2}} - \frac{{‖ {φ}_{t} ( s ) - {φ}_{t} ( {s}_{j} ) ‖}^{2}}{{σ}_{t}^{2}} ) \qquad [ Formula 11 ]$$

Note that Z is a value for normalization and is set such that the total of the joint probabilities p(x, s) for every classification object word x and every word sense s becomes 1; N is the number of classification object words x included in the input data; xᵢ is the i-th classification object word; wᵢ is a classification object word xᵢ in disregard of an appearing context; S_{wi} is a set of word sense candidates for the word wᵢ; sⱼ is a concept included in the set S_{wi}; π^{wi}ⱼ is the probability (word sense assignment probability) that the word sense of the word wᵢ is sⱼ; and σ_{c} and σₜ are respectively the dispersion of the feature space of the appearing context and the dispersion of the feature space of the word sense, and are given with predetermined values as preset values. In Formula 11, exp(·) is a Gaussian kernel, and ∥·∥² is a squared norm (of a differential vector).

From Supposition 1, the word sense assignment probability π^{wi}ⱼ does not depend on the appearing context. Note that the word wᵢ expresses, for example, word “SHIP”. In this case, the word sense sⱼ expresses fune, katagaki, and chukka. Since the word sense assignment probability π^{wi}ⱼ is a probability that the word wᵢ is assigned to a word sense candidate, if S_{wi} is the set of word sense candidates of the word wᵢ, the sum of every element sⱼεS_{wi} of the set S_{wi} is 1 (Formula 12).

$${\sum }_{j : {s}_{j} ∈ {S}_{{w}_{i}}} {π}_{j}^{{w}_{i}} = 1 \qquad [ Formula 12 ]$$

More specifically, in this case, the joint probability p(x, s) is obtained by kernel density estimation weighted by the word sense assignment probability π^{wi}ⱼ, based on every word sense hypothesis sⱼ (εS_{wi}) of every classification object word xᵢ (i=1, . . . , N).

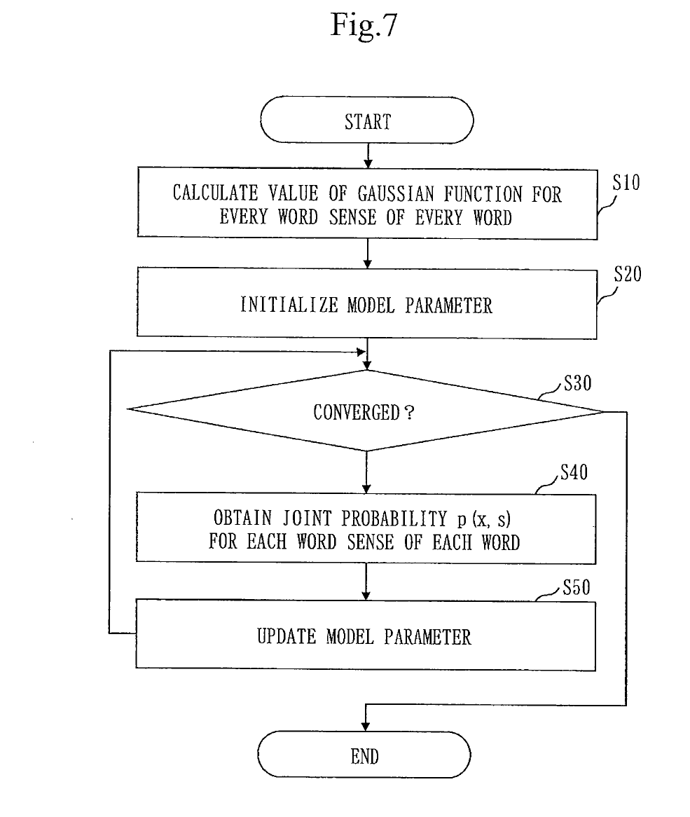

FIG. 7 is a flowchart showing the flow of a process (probability calculation) of estimating the word sense assignment probability π^{wi}ⱼ.

By adopting EM algorithm, the word sense assignment probability π^{wi}ⱼ can be estimated for every classification object word simultaneously.

### <S10: Preparation Step>

For the purpose of rendering the calculation in the repetition in and after S30 efficient, in Formula 11, the word sense estimation part 60 calculates the value of the Gaussian kernel exp(·) irrelevant to update of the word sense assignment probability π^{wi}ⱼ, and stores the calculation result in the storage device.

### <S20: Initialization Step>

The word sense estimation part 60 sets initial value 1/|S_{w}| to the word sense assignment probability π^{w}ⱼ for every word w. Note that |S_{w}| expresses the number of elements of the set S_{w}.

### <S30: Convergence Determination Step>

The word sense estimation part 60 obtains a total L of the word sense likelihoods for every classification object word x by Formula 13.

$$ℒ = {\sum }_{i = 1}^{N} {\sum }_{j : {s}_{j} ∈ {S}_{{w}_{i}}} log p ( {x}_{i} , {s}_{j} ) \qquad [ Formula 13 ]$$

Then, if the increment of the total L of the word sense likelihoods since the last repetition is less than a threshold θ given in advance, the word sense estimation part 60 determines that the convergence occurs, and ends the learning. If un-converged, the word sense estimation part 60 sets the process forward to S40, thereby repeating re-calculation and update of the word sense assignment probability π^{w}ⱼ.

### <S40: E Step>

The word sense estimation part 60 obtains the joint probability p(x, s) by Formula 11 based on the current word sense assignment probability ^{(old)}π^{w}ⱼ, for every word sense candidate s of every classification object word s. As the value of the Gaussian kernel exp(·) the value stored in the storage device in S10 is utilized.

### <S50: M Step>

The word sense estimation part 60 calculates new word sense assignment probability ^{(new)}π^{w}ⱼ by Formula 14, and sets the process back to S30.

$${}_{}^{( new )}{π}{}_{s}^{w} := \frac{{\sum }_{{x}_{i} ∈ {X}_{w}} p ( {x}_{i} , s )}{{\sum }_{{x}_{i} ∈ {X}_{w}} {\sum }_{{s}_{j} ∈ {S}_{w}} p ( {x}_{i} , {s}_{j} )} \qquad [ Formula 14 ]$$

Note that X_{w} is a set of classification object words x included in the input text data 10.

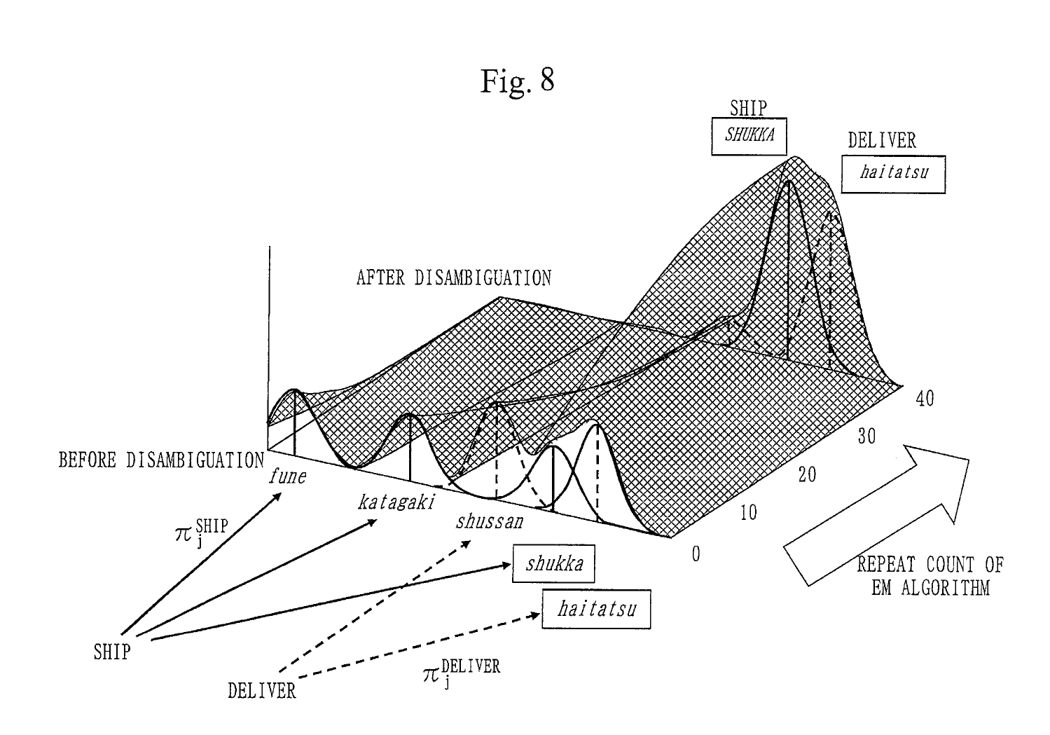

FIG. 8 shows update of the word sense assignment probability π^{w}ⱼ conducted by adopting the EM algorithm and how word sense disambiguation takes place accordingly.

FIG. 8 shows the simulation result of an operation that changes from the left state to the right state in FIG. 2 along with a repetition of the π^{w}ⱼ update step of the EM algorithm. The graph in the left of FIG. 2 corresponds to the position (before disambiguation) in lower left of FIG. 8 where the EM algorithm is repeated 0 times, and the graph in the right of FIG. 2 corresponds to the position (after disambiguation) in upper right of FIG. 8 where the EM algorithm is repeated 40 times. Note that in FIG. 8, for the sake of simplicity, the Gaussian distribution is shown to include only 3 bell curves expressing the word sense candidates for “SHIP” and 2 bell curves expressing the word sense candidates for “DELIVER”, which appear in contexts close to each other.

It is apparent from FIG. 8 that in the initial state, the 3 word senses (fune, katagaki, and shukka) of the word “SHIP” are probable almost equally, and the 2 word senses (shussan and haitatsu) of the word “DELIVER” are probable almost equally. However, regarding the word sense shukka for “SHIP” and the word sense haitatsu for “DELIVER” which are located close to each other, as the tails of their likelihoods by Gaussian kernel overlap, they can be estimated to be more plausible than the other word senses. In this manner, the word sense expected value of each word is estimated from the whole probability density predicted based on the similarity with respect to the other word senses of another word which appears in a similar context, and the word sense assignment probability π^{w}ⱼ of each word is updated repeatedly so as to match with the estimated word sense expected value of each estimated word. As a result, the value of the word sense assignment probability π^{w}ⱼ of each word changes as shown in FIG. 8, and eventually the probability of the plausible word sense of each word increases.

Upon completion of the estimation of the word sense assignment probability π^{w}ⱼ, the word sense estimation part 60 selects the most plausible word sense sⱼ* for each classification object word w by Formula 15, and outputs it as the estimated word sense data 70.

$${s}_{{j}^{*}} = arg {max}_{j} {π}_{j}^{w} \qquad [ Formula 15 ]$$

As described above, the word sense estimation device 100 finds close word sense assignment from among words whose features of the appearing contexts are close. Thus, the word sense can be estimated from data not given with the correct word sense.

Therefore, the problem in the scheme which uses supervised learning and in the scheme which uses semi-supervised learning, that labeled learning data to which a correct word sense is imparted usually manually need be generated for the text data of an object task, can be solved. As a result, it is possible to solve the problem of the costly learning data generation and the problem that these schemes cannot be employed where the learning data cannot be obtained in advance.

Using the EM algorithm, the word sense estimation device 100 repeatedly updates the word assignment probability of every word as the classification object, so that it solves the ambiguities of every word simultaneously and gradually. Namely, the word sense of a word is estimated based on the most plausible word senses of other words.

Hence, it is possible to solve the problem of poor word sense estimation accuracy in the scheme described in Patent Literature 1, which is caused because the word sense candidates of the co-occurrence words are utilized as the support for the word in question by treating equally significantly even a word sense candidate that is actually false.

In fine, with the word sense estimation device 100, it is possible to solve the problems of conventional word sense estimation technique, so that the word sense can be estimated highly accurately by unsupervised learning even if labeled learning data cannot be obtained.

The above explanation is based on a condition that the classification object word is a word (registered word) registered in the concept dictionary 50 and that a word sense candidate can be obtained by looking up the concept dictionary 50. However, the above scheme can be adopted even if the classification object word is a word not registered in the concept dictionary 50 (unregistered word).

For example, abbreviation “DELIV” for registered word “DELIVER” is an unregistered word. In this case, with respect to the notation character string of the classification object word, which is an unregistered word, and the character string of the registered word of the concept dictionary 50, the character-string to character-string similarity degree is obtained based on a known edit distance or the like. Every registered word having a similarity degree higher than a predetermined threshold may be extracted, and a concept stored as the word sense of the extracted registered word may be determined as the word sense candidate.

In this case, a joint probability p(x, s) may be calculated using a weight that matches the character-string to character-string similarity degree with respect to the extracted registered word. For example, assume that a word sense sⱼ of a classification object word wᵢ, being an unregistered word, is a concept registered as the word sense for a registered word ŵᵢ similar to the classification object word wᵢ. Also assume that the weight that matches the character-string to character-string similarity degree between the classification object word wᵢ and the registered word ŵᵢ is ωⱼⁱ. In this case, the word sense assignment probability π^{wi}ⱼ in Formula 1 may be multiplied by the weight ωⁱⱼ to yield such that the higher the character-string to character-string similarity degree with respect to the extracted registered word, the higher the word sense assignment probability π^{wi}ⱼ.

The above explanation is directed to the operation of estimating the word sense for every word included in the input text data 10. However, the present invention need not be limited to this, but can also be applied to a case where the correct word senses are fixed in advance for some words included in the input text data 10.

In that case, for a word to which the correct word sense is imparted, the word sense assignment probability π^{w}ⱼ of the correct word sense sⱼ may be fixed to 1. That way, it is possible to apply the above scheme to semi-supervised learning, to perform word sense estimation more accurately than in a case where the above scheme is applied to complete unsupervised learning.

In the above explanation, the word sense assignment probability π^{w}ⱼ is obtained as a continuous value between 0 and 1. However, the present invention is not limited to this. For example, in place of Formula 4, a probability π^{w}_{ĵ}=1 may hold only for ĵ with which π^{w}ⱼ calculated by Formula 4 takes a maximum value, and π^{w}ⱼ=0 may hold for the other j.

In the above explanation, the objects to be summed in Formula 1 are every word sense hypothesis of every classification object word. However, the present invention is not limited to this. For example, the object may be limited to predetermined K (K is an integer of 1 or more) of word sense hypotheses whose word sense feature vectors are close, and these predetermined K of word sense hypotheses may be summed.

In the above explanation, the feature vector of the appearing context is expressed simply based on whether a co-occurrence word exists. However, the present invention is not limited to this. For example, the dictionary may be searched for a co-occurrence word, and a concept to serve as the word sense candidate of the co-occurrence word may be extracted. The context may be re-described by substituting the extracted concept for the co-occurrence word described in an expression form or a lemma form. Then, the feature vector of the appearing context may be expressed. More specifically, if a word “ship” appears as a co-occurrence word, the context is re-described by substituting concepts: fune, katagaki, and shukka for “ship”, and the feature vector of the appearing context is expressed. Hence, assuming, for example, a context in which a word “ship” appears as a co-occurrence word and a context in which a word “vessel” appears as a co-occurrence word, the two appearing contexts have feature vectors that are close to each other.

In the above explanation, the proximity in the context and the proximity in the word sense are modeled using Gaussian kernel. However, the present invention is not limited to this. For example, the proximity in the word sense may be simply substituted by the number of links along which the hierarchies of the concept dictionary are traced.

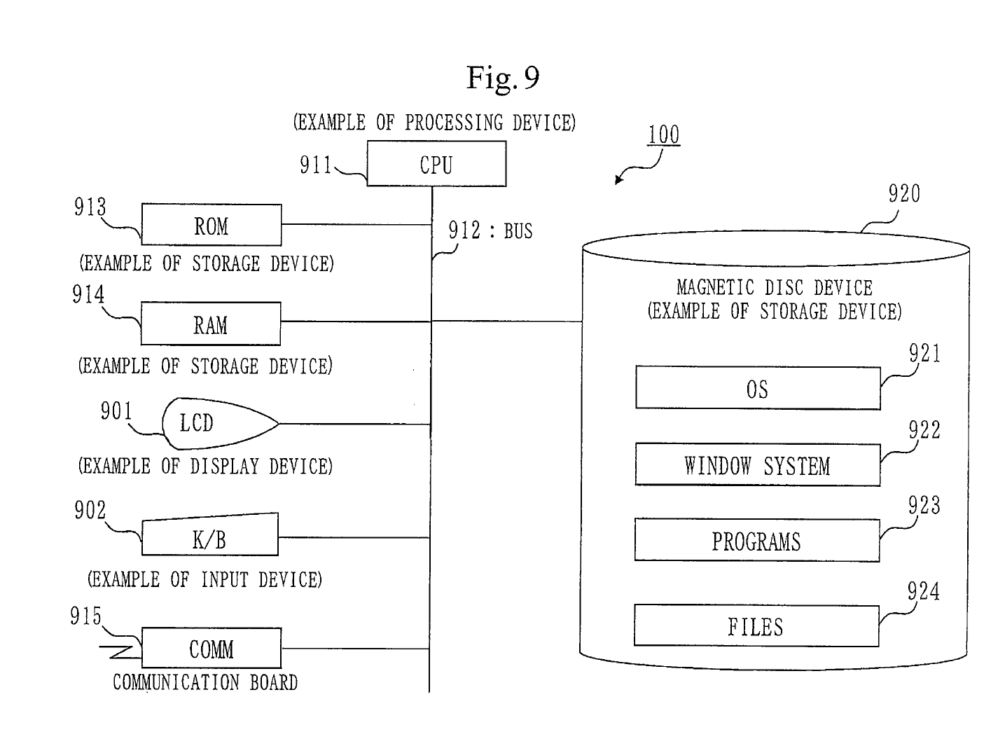

FIG. 9 shows an example of the hardware configuration of the word sense estimation device 100.

As shown in FIG. 9, the word sense estimation device 100 is provided with the CPU 911 (Central Processing Unit; also referred to as a central processing device, processing device, computation device, microprocessor, microcomputer, or processor) which executes programs. The CPU 911 is connected to the ROM 913, the RAM 914, an LCD 901 (Liquid Crystal Display), a keyboard 902 (KB), a communication board 915, and the magnetic disk device 920 via a bus 912, and controls these hardware devices. In place of the magnetic disk device 920 (fixed disk device), a storage device such as an optical disk device or memory card read/write device may be employed. The magnetic disk device 920 is connected via a predetermined fixed disk interface.

The magnetic disk device 920, ROM 913, or the like stores an operating system 921 (OS), a window system 922, programs 923, and files 924. The CPU 911, the operating system 921, and the window system 922 execute each program of the programs 923.

The programs 923 store software and programs that execute the functions described as the “word extraction part 20”, “context analysis part 30”, “word sense candidate extraction part 40”, “word sense estimation part 60”, and the like in the above description. The programs 923 store other programs as well. The programs are read and executed by the CPU 911.

The files 924 store information, data, signal values, variable values, and parameters such as the “input text data 10”, “concept dictionary 50”, “estimated word sense data 70”, and the like of the above explanation, as the items of a “file” and “database”. The “file” and “database” are stored in a recording medium such as a disk or memory. The information, data, signal values, variable values, and parameters stored in the recording medium such as the disk or memory are read out to the main memory or cache memory by the CPU 911 through a read/write circuit, and are used for the operations of the CPU 911 such as extraction, search, look-up, comparison, computation, calculation, process, output, print, and display. The information, data, signal values, variable values, and parameters are temporarily stored in the main memory, cache memory, or buffer memory during the operations of the CPU 911 including extraction, search, look-up, comparison, computation, calculation, process, output, print, and display.

The arrows of the flowcharts in the above explanation mainly indicate input/output of data and signals. The data and signal values are recorded in the memory of the RAM 914, the recording medium such as an optical disk, or in an IC chip. The data and signals are transmitted online via a transmission medium such as the bus 912, signal lines, or cables; or electric waves.

The “part” in the above explanation may be a “circuit”, “device”, “equipment”, “means”, or “function”; or a “step”, “procedure”, or “process”. The “device” may be a “circuit”, “equipment”, “means”, or “function”; or a “step”, “procedure”, or “process”. The “process” may be a “step”. Namely, the “part” may be implemented as firmware stored in the ROM 913. Alternatively, the “part” may be practiced as only software; as only hardware such as an element, a device, a substrate, or a wiring line; as a combination of software and hardware; or furthermore as a combination of software, hardware, and firmware. The firmware and software are stored, as programs, in the recording medium such as the ROM 913. The program is read by the CPU 911 and executed by the CPU 911. Namely, the program causes the computer to function as the “part” described above. Alternatively, the program causes the computer or the like to execute the procedure and method of the “part” described above.

### REFERENCE SIGNS LIST

10: input text data; 20: word extraction part; 30: context analysis part; 40: word sense candidate extraction part; 50: concept dictionary; 60: word sense estimation part; 70: estimated word sense data; 100: word sense estimation device

1. A word sense estimation device comprising:
a word extraction part which extracts a plurality of words included in input data;
a context analysis part which extracts, for each word extracted by the word extraction part, a context feature of a context in which the word appears in the input data;
a word sense candidate extraction part which extracts each concept stored as a word sense of said each word, as a word sense candidate of said each word, from a concept dictionary storing at least one concept as a word sense of a word; and
a word sense estimation part which executes a plurality of number of times a probability calculation of calculating an evaluation value for said each word of a case where said each concept extracted as the word sense candidate by the word sense candidate extraction part is determined as a word sense, based on a proximity between the context feature of a selected word and the context feature of another word, a proximity between a selected concept and a concept of a word sense candidate of said another word, and a probability that the selected word takes a selected word sense, and of re-calculating the probability based on the evaluation value calculated, and which estimates a concept with a higher probability calculated of said each word, to be a word sense of the word.

2. The word sense estimation device according to claim 1,
wherein the word sense estimation part calculates the evaluation value such that: the closer the context features to each other, the higher the evaluation value; the closer the selected concept and a word sense of said another word to each other, the higher the evaluation value; and the higher the probability, the higher the evaluation value, and re-calculates the probability such that the higher the evaluation value calculated, the higher the probability.

3. The word sense estimation device according to claim 2,
wherein the word sense estimation part calculates a joint probability p(x, s) as an evaluation value, assuming that x is the selected word and s is the selected concept, by Formula 1:
$$p ( x , s ) ≡ \frac{1}{Z} {\sum }_{i = 1}^{N} {\sum }_{j : {s}_{j} ∈ {S}_{{w}_{i}}} {π}_{j}^{{w}_{i}} exp ( - \frac{{‖ {φ}_{c} ( x ) - {φ}_{c} ( {x}_{i} ) ‖}^{2}}{{σ}_{c}^{2}} - \frac{{‖ {φ}_{t} ( s ) - {φ}_{t} ( {s}_{j} ) ‖}^{2}}{{σ}_{t}^{2}} ) \qquad [ Formula 1 ]$$
where
Z is a predetermined value,
N is the number of words included in the input data,
xᵢ is an i-th word,
wᵢ is a word xᵢ in disregard of an appearing context.
S_{wi} is a set of word sense candidates for the word wᵢ,
sⱼ is a concept included in the set S_{wi},
π^{wi}ⱼ is a probability that a word sense of the word wᵢ is sⱼ,
φ_{c} is a vector representing a context feature,
φₜ is a vector representing a concept, and
σ_{c} and σₜ are predetermined values, respectively.

4. The word sense estimation device according to claim 3,
wherein the word sense estimation part calculates a probability π^{w}ₛ that the word x takes the concept s, by Formula 2:
$${}_{}^{( new )}{π}{}_{s}^{w} := \frac{{\sum }_{{x}_{i} ∈ {X}_{w}} p ( {x}_{i} , s )}{{\sum }_{{x}_{i} ∈ {X}_{w}} {\sum }_{{s}_{j} ∈ {S}_{w}} p ( {x}_{i} , {s}_{j} )} \qquad [ Formula 2 ]$$
where X_{w} is a set of words included in the input data.

5. The word sense estimation device according to claim 4,
wherein the word sense estimation part calculates a total likelihood L in the probability calculation by Formula 3, repeatedly until an increment of a total likelihood L calculated in an (n+1)-th probability calculation, n being an integer of 1 or more, with respect to a total likelihood L calculated in an n-th probability calculation becomes less than a predetermined threshold θ:
$$ℒ = {\sum }_{i = 1}^{N} {\sum }_{j : {s}_{j} ∈ {S}_{{w}_{i}}} log p ( {x}_{i} , {s}_{j} ) \qquad [ Formula 3 ]$$

6. The word sense estimation device according to claim 5,
wherein the word sense estimation part, for said each word, substitutes 1 for the probability π^{w}ₛ, being highest, of a word sense candidate, the probability π^{w}ₛ being calculated by Formula 2, and 0 for the probability π^{w}ₛ of another word sense candidate, calculates the total likelihood L, and re-calculates the evaluation value.

7. The word sense estimation device according to claim 1,
wherein the context feature includes at least either one of a neighboring word of the selected word and a word included in another character string associated to a character string including the selected word.

8. The word sense estimation device according to claim 1,
wherein the context feature includes at least either one of a word sense of a neighboring word of the selected word and a word sense of a word included in another character string associated to a character string including the selected word.

9. The word sense estimation device according to claim 1,
wherein a concept stored in the concept dictionary as a word sense of a word is set with a hierarchical relation expressed by a graph structure, and a proximity between two concepts is determined by the number of links between the concepts.

10. The word sense estimation device according to claim 1,
wherein, in a case where a word extracted by the word extraction part is not registered in the concept dictionary, the word sense candidate extraction part specifies, from the concept dictionary, a word having a similarity of at least a predetermined degree with respect to a character string that constitutes the word, and extracts each concept stored as a word sense for the word specified, as a word sense candidate for the word extracted by the word sense candidate extraction part.

11. The word sense estimation device according to claim 1,
wherein, in a case where a word sense of a certain word is given in advance, the word sense estimation part fixes the probability of a word sense candidate corresponding to the given word sense among word sense candidates to 1, and fixes the probabilities of remaining word sense candidates to 0.

12. A word sense estimation method comprising:
a word extraction step of, with a processing device, extracting a plurality of words included in input data;
a context analysis step of, with the processing device, extracting, for each word extracted in the word extraction step, a context feature of a context in which the word appears in the input data;
a word sense candidate extraction step of, with the processing device, extracting each concept stored as a word sense of said each word, as a word sense candidate of said each word, from a concept dictionary storing at least one concept as a word sense of a word; and
a word sense estimation step of, with the processing device: executing a plurality of number of times a probability calculation of calculating an evaluation value for said each word of a case where each concept extracted as the word sense candidate in the word sense candidate extraction step is determined as a word sense, based on a proximity between the context feature of a selected word and the context feature of another word, a proximity between a selected concept and a concept of a word sense candidate of said another word, and a probability that the selected word takes a selected word sense, and of re-calculating the probability based on the evaluation value calculated; and estimating a concept with a higher probability calculated of said each word, to be a word sense of the word.

13. A word sense estimation program adapted to cause a computer to execute:
a word extraction process of extracting a plurality of words included in input data;
a context analysis process of extracting, for each word extracted in the word extraction process, a context feature of a context in which the word appears in the input data;
a word sense candidate extraction process of extracting each concept stored as a word sense of said each word, as a word sense candidate of said each word, from a concept dictionary storing at least one concept as a word sense of a word; and
a word sense estimation process of: executing a plurality of number of times a probability calculation of calculating an evaluation value for said each word of a case where each concept extracted as the word sense candidate in the word sense candidate extraction process is determined as a word sense, based on a proximity between the context feature of a selected word and the context feature of another word, a proximity between a selected concept and a concept of a word sense candidate of said another word, and a probability that the selected word takes a selected word sense, and of re-calculating the probability based on the evaluation value calculated; and estimating a concept with a higher probability calculated of said each word, to be a word sense of the word.
